(19) United States
(12) Patent Application Publication
(10) Pub. No.: US 2005/0023976 A1
(43) Pub. Date: Feb. 3, 2005

(54) Seal and sealing process for electroluminescent displays

(76) Inventor: Yuxin Wang, Mississauga (CA)

Correspondence Address: James W. McKee;Fay, Sharpe, Fagan, Minnich & McKee, LLP, 7th Floor, 1100 Superior Avenue, Cleveland, OH, 44114-2518, US

(21) Appl. No.: 10/885,257

(22) Filed: Jul. 6, 2004

Related U.S. Application Data
(60) Provisional application No. 60/484,666, filed on Jul. 7, 2003.

(51) Int. Cl. H01J 1/62

(52) U.S. Cl. 313/512

(57) ABSTRACT

The present invention is a sealed electroluminescent display that incorporates a perimeter seal that inhibits exposure of display components to atmospheric contaminants and to a sealing process for fabrication of the same. The sealed electroluminescent display comprises a substrate, a cover plate and an electroluminescent display structure between the substrate and the cover plate. A perimeter seal is provided that extends from the substrate to the cover plate to inhibit exposure of the electroluminescent display structure to an atmospheric contaminant. The perimeter seal comprises one or more layers of a sealing material wherein at least one of the layers further comprises a getter material.

### FIELD OF THE INVENTION

The present invention relates to electroluminescent displays. In particular, the present invention relates to an electroluminescent display having a perimeter seal that inhibits exposure of display components to at least one atmospheric contaminant and to a sealing process for fabrication of the same.

### BACKGROUND TO THE INVENTION

Exposing conventional electroluminescent displays to atmospheric contaminants is known to shorten the life of displays. To protect electroluminescent displays, various types of seals have been utilized.

In electroluminescent displays employing thin film phosphors, phosphor materials are typically sandwiched between a pair of addressable electrodes, and usually fabricated on a glass, a glass ceramic, ceramic, or other heat resistant substrate. The phosphor materials are activated by application of an electric field generated between the electrodes. These displays can be protected from atmospheric contaminants by placing a chemically impervious cover plate over the fabricated display and by sealing the perimeter between the substrate and the cover plate with a perimeter seal in order to isolate the phosphor material and electrodes between the substrate and the cover plate, as exemplified in Applicant's co-pending U.S. patent application Ser. No. 60/406,661. In some cases, the cover plate is on the viewing side of the display, in which case it must be optically transparent, and in other cases, the display is constructed on an optically transparent viewing-side substrate and the cover plate is positioned opposite the viewing side.

Full colour thick film dielectric electroluminescent displays, employing thin film phosphors and thick film dielectric layers, provide a greater luminance and superior reliability over traditional thin film electroluminescent displays. Thick film dielectric electroluminescent displays typically employ phosphor materials and insulator materials that are susceptible to degradation due to reaction with atmospheric vapours. Further, the thick dielectric layer of such displays, which enhances the luminosity of the displays to usable levels, may also be susceptible to degradation due to reaction with atmospheric contaminants.

A thick film dielectric electroluminescent display is typically constructed on a glass, glass ceramic, ceramic, or other heat resistant substrate or the like. The fabrication process for the display entails first depositing a set of lower electrodes on the substrate. A thick film dielectric layer is deposited next using thick film deposition techniques that are exemplified in U.S. Pat. No. 5,432,015 (the disclosure of which is incorporated herein by reference in, its entirety). A thin film structure comprised of one or more thin film dielectric layers sandwiching one or more thin phosphor films is then deposited, followed by a set of optically transparent upper electrodes using vacuum techniques as exemplified by International Patent Application WO 00/70917 (the disclosure of which is incorporated herein in its entirety). To minimize exposure of the layers to atmospheric contaminants, a similar arrangement to that described for the thin film electroluminescent display may be used, as exemplified in Applicant's co-pending U.S. patent application Ser. No. 60/406,661.

U.S. Pat. No. 5,920,080 discloses an organic light emitting device (OLED) that has incorporated a sealing layer between a barrier layer and a colour converter layer to protect the device from oxygen and moisture. The sealing layer may cover several OLEDs within a display and may also include a heat adhesive perimeter seal solely about the OLED within the device.

U.S. Pat. No. 6,081,071 discloses an organic electroluminescent device sandwiched between a glass substrate and a glass cover. First and second seals are used to seal the glass substrate and glass cover. Dessicant and/or inert fluorocarbon liquid is provided between the first and second seals.

U.S. Pat. No. 6,210,815 discloses an organic thin film electroluminescent device having a transparent substrate and a sealing cap bonded together by an adhesive. The adhesive may be a combination of adhesives with different hardening conditions.

U.S. patent application Ser. No. 2002/0054270 discloses a liquid crystal display that has first and second substrates sealed around the periphery with the liquid crystal material being sandwiched between the substrates.

U.S. Pat. No. 6,146,225 discloses a barrier for preventing water or oxygen from reaching an organic light emitting device. The barrier comprises layers of polymer having on inorganic layer therebetween. A getter material can be provided in the inorganic layer or as a separate layer between the polymer layers and the display. This type of barrier tends to have limited utility due to the large area to thickness ratio which results in a relatively high rate of transport of vapour species therethrough.

While the aforementioned references may teach the use of various types of seals and seal arrangements for electroluminescent displays, these seals and seal arrangements may not significantly immobilize the flux of atmospheric contaminants into the electroluminescent displays. Therefore, there still remains a need for a proper seal and sealing process for electroluminescent displays in order to improve their operating stability.

### SUMMARY OF THE INVENTION

The invention is directed to a seal and sealing process for electroluminescent displays to improve operating stability of the displays. The seal is a perimeter seal which contacts and extends from the substrate of the display to the cover plate of the display to effectively minimize the flux of atmospheric contaminants that may negatively affect the electroluminescent display structure that is provided in between the cover plate and the substrate. In other words, the perimeter seal occupies the entire height of the gap between the substrate and the cover plate. The perimeter seal does not impede the functioning of the electroluminescent display structure. The provision of the perimeter seal helps to increase the operational device of the electroluminescent display in which it is incorporated.

In a first embodiment, the perimeter seal of the invention is a single layer seal that comprises a getter material and a sealing material. The seal is provided about the perimeter of an electroluminescent display which is the outer boundary of the display. In other aspects of the invention, the perimeter seal comprises the first single layer seal as just described with a second outer layer comprising sealing material that may or may not have a getter material provided therein. This forms a double seal. Still in other aspects of the invention, the perimeter seal of the invention may comprise a plurality of layers of sealing material wherein one or more of the layers additionally comprises a getter material. Preferably, when the perimeter seal comprises two or more layers, the layers are directly adjacent and in contact with each other.

In accordance with an aspect of the present invention is a perimeter seal for an electroluminescent display having a cover plate, a substrate and a electroluminescent display structure therebetween, said perimeter seal comprising;
one or more layers of a sealing material, wherein at least one of said layers of sealing material additionally comprises a getter material, wherein said perimeter seal contacts and forms a seal between said cover plate and said substrate. In preferred aspects, the perimeter seal does not contact the electroluminescent display structure.

In accordance with another aspect of the present invention, there is provided a sealed electroluminescent display comprising:
a substrate;
a cover plate;
an electroluminescent display structure between the substrate and the cover plate; and
a perimeter seal contacting and extending from the substrate and to the cover plate to inhibit exposure of the electroluminescent display structure to an atmospheric contaminant.

In accordance with other aspects of the invention, the getter material is an atmospheric contaminant-immobilizing material that is uniformly distributed throughout the sealant material such that an atmospheric contaminant permeating through the perimeter seal is encountered and absorbed the getter material. The getter material may also function to getter at least one atmospheric contaminant trapped within the electroluminescent display.

In accordance with another aspect of the invention, the concentration of the getter material is at least about 5% and at most about 50% of the sealing material volume and more preferably, between about 10 and about 30% of the sealing material volume forming any layer of the perimeter seal.

In further aspects, the getter material has a particle size that should not exceed the thickness of the perimeter seal whether provided as a single, double or multiple layer seal. Preferably, the getter material has a particle size in the range of from about 0.1 to about 250 micrometers.

In other aspects of the invention, the getter material is selected from the group consisting of alkali metal oxides, alkali metal sulfates, alkaline earth metal oxides, alkaline earth metal sulfates, calcium chloride, lithium chloride, zinc chloride, perchlorates and mixtures thereof. The getter material may also be selected from the group consisting of molecular sieves, calcium oxide, barium oxide, phosphorus pentoxide, calcium sulfate and mixtures thereof.

In accordance with another aspect of the present invention the sealing material is selected from the group consisting of UV or thermally curable adhesives. The sealing material may be selected from the group consisting of epoxies, phenoxies, cellulose acetates, siloxanes, methacrylates, sulfones, phthalates and mixtures thereof.

The viscosity of the sealing material, prior to curing, is less than about 2500 poise and greater than about 10 poise.

In accordance with another aspect of the present invention, the electroluminescent display structure is selected from the group consisting of a thick film dielectric electroluminescent display structure and a thin film electroluminescent display structure.

In accordance with another aspect of the present invention, there is provided a process for making a sealed electroluminescent display having a substrate, a cover plate and an electroluminescnet structure therebetween, the process comprising:
depositing a perimeter seal around the perimeter of said substrate and/or a cover plate, wherein said perimeter seal comprises a mixture of at least one getter material and at least one sealing material; and
curing said seal.

### BRIEF DESCRIPTION OF THE DRAWINGS

The present invention will become more fully understood from the detailed description given herein and from the accompanying drawings, which are given by way of illustration only and do not limit the intended scope of the invention.

FIG. 1 is a top plan view of an electroluminescent display in accordance with a first embodiment of the perimeter seal of the present invention, the cover seal is shown partially cut away;

FIG. 1A is a partial sectional view of the electroluminescent display of FIG. 1;

FIG. 2 is a sectional view of the electroluminescent display of FIG. 1 shown in detail;

FIG. 3 is a top plan view of an electroluminescent display in accordance with a second embodiment of the perimeter seal of the present invention, the cover seal is shown partially cut away;

FIG. 3A is a partial sectional view of the electroluminescent display of FIG. 3;

FIG. 4 is a sectional view of the electroluminescent display of FIG. 3 shown in detail;

FIG. 5 is a graphical representation of the moisture uptake rate for 13× molecular sieve powder in a blend of UV curable adhesives of Example 1;

FIG. 6 is a graphical representation of the moisture uptake rate for 13× molecular sieve powder in a UVS91 UV curable adhesive of Example 2;

FIG. 7 is a graphical representation of the rate of moisture removal from a sealed cell containing 13× molecular sieve powder in a UVS91 UV curable adhesive of Example 3;

FIG. 8 is a cross section of a moisture penetration test cell of Example 4, which is set up to measure moisture penetration through a seal of Example 4;

FIG. 9 is a cross section of a moisture penetration test cell of Example 4, which is set up to measure the dynamic moisture content in the cell as a result of the balance between moisture penetration through a seal of Example 4 and moisture absorption by a film comprising getter material of Example 5 within the test cell;

FIG. 10 is a cross section of a moisture penetration test cell of Example 4, which is set up to measure moisture penetration through a double seal of Example 6 with the inner perimeter seal incorporating getter material;

FIG. 11 is a graph showing moisture penetration as a function of time into a moisture penetration test cell placed in a high humidity environment and set up to evaluate different seal and moisture control configurations of Examples 4, 5 and 6;

FIGS. 12A-12D show top plan views and partial cross sections of four test electroluminescent devices with different sealing arrangements; and

FIG. 13 shows the luminance versus storage time for the four test electroluminescent devices with different sealing arrangements.

### DETAILED DESCRIPTION OF THE PREFERRED EMBODIMENTS

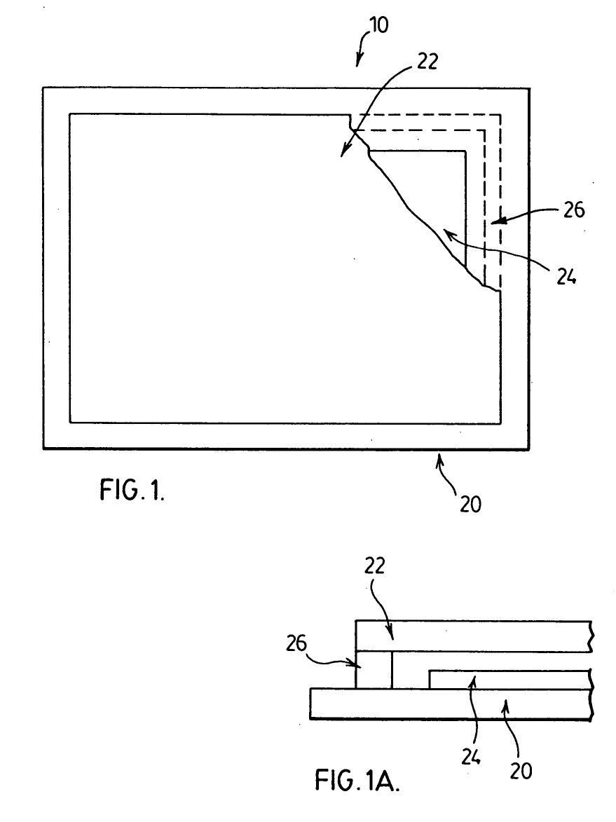

The present invention is a novel seal and sealing process for an electroluminescent display. The seal is a perimeter seal that sufficiently and substantially immobilizes the integrated flux of at least one atmospheric contaminant, for instance, atomic or molecular species such as oxygen and water, from adversely affecting the electroluminescent display structure. Preferred embodiments of a sealed electoluminescent display of the present invention are shown in FIGS. 1 to 4.

The perimeter seal of the invention in a first embodiment comprises a getter material and a sealing material. The getter material is an atmospheric contaminant-immobilizing material. This perimeter seal is provided as a single layer that contacts both the cover plate and the substrate of an electroluminescent display such that the gap between the cover plate and the substrate is completely sealed. Reference is first made to FIGS. 1 and 1A, which show a top plan view and a partial sectional view, respectively, of this first embodiment of a sealed electroluminescent display, generally indicated by reference numeral 10. The electroluminescent display 10 has a substrate 20, a cover plate 22, an electroluminescent display structure 24 therebetween, and a perimeter seal 26 between the substrate 20 and the cover plate 22 for protecting the electroluminescent display structure 24 from one or more atmospheric contaminants. The perimeter seal 26 is shown to extend and be in contact with the cover plate 22 and the substrate 20 and thus fills the entire gap between the cover plate 22 and the substrate 20. The perimeter seal 26 does not contact the electroluminescent display structure 24.

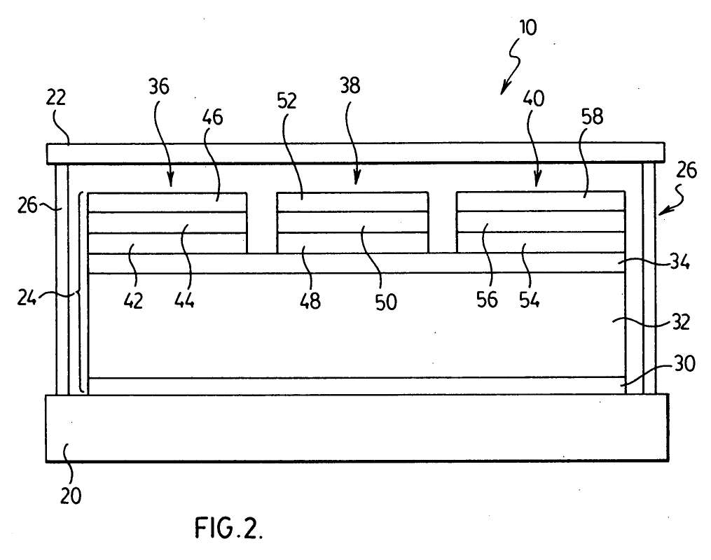

FIG. 2 shows an electroluminescent display 10 of FIGS. 1 and 1A in more detail where the display incorporates a thick film dielectric layer within the electroluminscent display structure 24. The substrate 20 has a row electrode 30 located thereon, followed by a thick film dielectric layer 32 and then a thin film dielectric layer 34. The thin film dielectric layer 34 is shown with three pixel columns 36, 38, and 40 located thereon. The pixel columns 36, 38 and 40 contain phosphor layers to provide the three basic colours viz. red, green and blue. Pixel column 36 has red phosphor layer 42 located on thin film dielectric layer 34. Another thin film dielectric layer 44 is located on red phosphor layer 42, and a column electrode 46 is located on thin film dielectric layer 44. Similarly, pixel column 38 has green phosphor layer 48 located on thin film dielectric layer 34, with another thin film dielectric layer 50 and a column electrode 52 located thereon. Pixel column 40 has blue phosphor layer 54 located on thin film dielectric layer 34, with thin film dielectric layer 56 and a column electrode 58 located thereon. The cover plate 22 is disposed over the substrate facing the deposited layers and is sealed to the substrate with the perimeter seal 26.

The perimeter seal comprises a getter material and a sealing material. The getter material is dispersed throughout the sealing material such that at least one atmospheric contaminant permeating through the seal will be encountered and absorbed by the getter material before the contaminants can penetrate through the entire thickness of the seal and enter into the space between the substrate 20, upon which the electroluminescent display structure 24 is built, and the overlying cover plate 22. The getter material may also function to getter contaminants that are trapped within the electroluminescent display upon its manufacture.

In preferred embodiments, the maximum loading of getter material per unit volume of sealing material is about 50%. If the getter material loading is higher, the viscosity of the sealing material increases and the material becomes more difficult to spread. Preferably, the getter loading per unit volume is at least about 5%, more preferably, the getter material concentrations are between about 10% and about 30% of the sealing material volume, and most preferably between about 15% and about 25% of the sealing material volume.

Ideally, the getter material is uniformly distributed throughout the sealing material and there are no cracks or channels in the sealing material at the interfaces between the seal and the substrate 20 and between the seal and the cover plate 22 through which vapour may penetrate the seal without coming into contact with the getter material.

Getter materials are any atmospheric contaminant-immobilizing materials, for example, materials that absorb water. Suitable getter materials include, but are not limited to, alkali metal oxides, alkali metal sulfates, alkaline earth metal oxides, alkaline earth metal sulfates, calcium chloride, lithium chloride, zinc chloride, perchlorates and mixtures thereof. Preferred getter materials include molecular sieves, calcium oxide, barium oxide, phosphorus pentoxide, calcium sulfate and mixtures thereof.

The getter material may have a particle size in the range of from about 0.1 to about 250 micrometers, depending on the seal thickness. Preferably, the particle size is selected so that it is sufficiently small such that the spacing between the particles is sufficiently small that vapours will readily come into contact with the getter particles during their transit within the seal. The particle size may also be sufficiently small that a smooth spreading of the sealing material during the seal formation process is achieved and that the particle dimensions do not exceed the thickness of the perimeter seal.

The sealing material helps to adhere the substrate to the cover plate and also acts as a matrix for the getter material. Suitable materials for the sealing material include, but are not limited to, UV or thermally curable adhesives that can be cured by directing UV light through the cover plate 22 or by heating the display. The substrate and cover plate may be adequately wetted to ensure that there are no voids between the seal and the substrate and/or the cover plate and to achieve adequate bonding strength to them. Preferably, the viscosity of the sealing material, prior to curing, is less than 2500 poise and greater than about 10 poise to facilitate adequate sealant spreading during seal formation.

Sealing materials can be selected from monomers and polymers, including epoxies, phenoxies, cellulose acetates, siloxanes, methacrylates, sulfones, phthalates and mixtures thereof. It is desirable to select easily worked materials with low moisture content, such as commercial sealing materials used for electronic components.

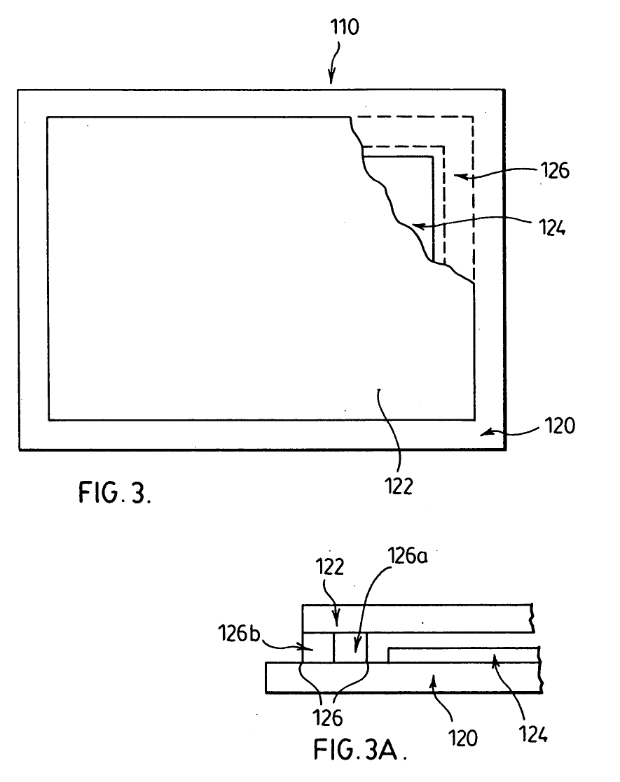

FIGS. 3 and 3A show a top plan view and a partial sectional view, respectively, of a second embodiment of the invention showing a sealed electroluminescent display generally indicated by reference numeral 110. The electroluminscent display 110 has a substrate 120, a cover plate 122 and an electroluminescent display structure 124 therebetween. A perimeter seal 126 is provided between the substrate 120 and the cover plate 122. In this embodiment, the perimeter seal 126 comprises an inner layer 126a and an outer layer 126b. The inner layer 126a comprises a sealing material and a getter material. The outer layer 126b comprises a sealing material without a getter material. Substantially all of the flux of an atmospheric contaminant that may end up passing through the outer layer 126b will pass through to the inner layer 126a and be chemically immobilized. Further, the inner layer 126a has a controlled and functionally uniform porosity so that substantially all of the flux of an atmospheric contaminant comes into contact with the getter material rather than passing through the layer of the perimeter seal 126.

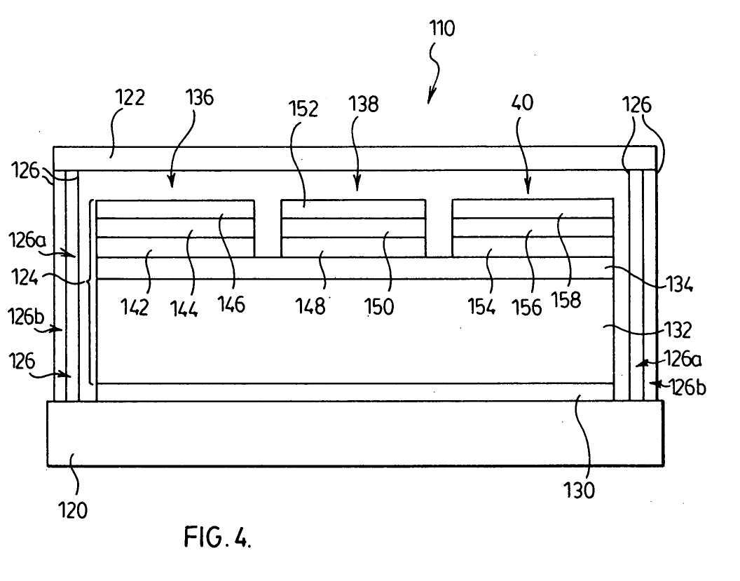

FIG. 4 shows the display 110 of FIGS. 3 and 3A with similar detail of the display to that shown in FIG. 2. In this particular embodiment, the perimeter seal 126 is shown as having the inner layer 126a and outer layer 126b as described for FIGS. 3 and 3A.

In the second embodiment of the perimeter seal having an inner and outer layer as shown in FIGS. 3, 3A and 4, it is desirable that no space be provided between the two layers of the seal, as such a space would cause the seal to occupy a larger area of the display substrate, which is generally undesirable.

The actual thickness of the perimeter seal of the present invention, that is the distance from the cover plate to the substrate, is dependent upon the thickness of the display structure fabricated on the substrate as is understood by one of skill in the art. The thickness may range from about 5 micrometers to about 2 millimeters and any desired thickness in between these ranges. A typical thickness is from about 25 to about 35 micrometers.

The width of the perimeter seal is dependent upon the tolerable transport rate of atmospheric contaminants. The tolerable transport rate of atmospheric contaminants depends on the perimeter seal thickness, the display area, the selection of sealing material, the selection of getter material and loading of getter material. The range of perimeter seal width may be from about 0.5 to about 15 millimeters, preferably, from about 1.5 to about 4 millimeters. When the perimeter seal comprises a single layer of sealing material and getter material (i.e. the first preferred embodiment), a wider seal width can be used commensurate with the substrate area available for the seal. The width of the perimeter seal containing the getter material may be determined by measuring, relative to the requirements for the display, the maximum permissible permeation rate of atmospheric contaminants through the seal. Generally, the probability per unit thickness of the contaminant being absorbed is approximately proportional to the quantity of the getter material, provided that the particle size for the getter material is comparable to or smaller than the thickness of the seal.

In the second embodiment of the perimeter seal 126 having an inner layer 126a and an outer layer 126b, the width of the inner layer 126a is similar to that of the outer layer 126b, but the width of the inner layer 126a is preferably chosen based on the required life of the display, which in turn is dependent upon the accumulated leakage of atmospheric contaminants through the inner and outer layers.

In the invention, it is typical that a small gap is left between an inner edge of the perimeter seal and the active area of the display structure (i.e. the electroluminescent display structure) to allow for spreading of the seal when the cover plate is pressed onto the substrate. It is desirable that the perimeter seal not flow over some of the layers of the display structure such as the thick dielectric layer that may not be completely covered by adjacent layers as this may allow lateral diffusion of atmospheric contaminants into the active area of the display structure.

The perimeter seal of the invention, in general, occupies the entire height of the gap between the substrate and the cover plate of the display so that there is no path around the seal for atmospheric contaminants to pass and as such it is a hermetic seal. More specifically, with respect to a perimeter seal that is provided as a single layer comprising a sealing material and a getter material, the perimeter seal should occupy the entire height of the gap between the substrate and the cover plate so that the getter material has the chance to absorb the contaminant before it can enter the internal space of the active area of the display structure.

The perimeter seal of the invention has been described in embodiments as comprising:
(a) a first embodiment of a single layer comprising a sealing material and getter material; and
(b) a second embodiment of a double layered structure that comprises an inner layer as described in (a) and having a further outer layer comprising a sealing material.

However, other embodiments of the perimeter seal are encompassed in the present invention. For example, the perimeter seal of the invention may comprise a plurality of layers of sealant material where any one of the layers also comprises a getter material. While it is most preferred to have a perimeter seal where the innermost layer comprises both sealant material and getter material, it is possible that the inner layer only comprises sealant material and an outer layer, or outer layers, comprises sealant material and getter material.

Furthermore, getter material used in the perimeter seal of the invention may comprise mixtures of different getter materials used in one or any number of layers of the perimeter seal. In other words, in the second embodiment of the invention, the getter material used may be different from the inner layer to the outer layer. Similar variations in sealing materials are also possible.

As provided as a layered perimeter seal structure comprising two or more layers of sealant material with our without getter material in any one of the layers, it is understood by one of skill in the art that the layers are provided in a generally but not strictly concentric manner. In other words, in a perimeter seal comprising more than one layer, the layers are within another and together outline the outer border, i.e. the periphery of the electroluminescent device which is being sealed. The layers are provided within one another and adjacent one another to effectively seal the electroluminescent device. It is also understood by one of skill in the art that an “inner” layer refers to a layer closest to the electroluminescent device structure, and “outer” layer refers to a layer that is further away from the electroluminescent device structure as shown in the figures.

With respect to suitable materials for the substrate and cover plate, suitable materials for the substrate are a glass, a glass ceramic, ceramic, or other heat resistant substrate or the like. For a more flexible display, a gas impermeable flexible substrate could also be used. Suitable materials for the cover plate include glass or other gas impermeable optically transparent sheet materials. Preferably, the cover plate has a thermal expansion coefficient substantially matched to that of the substrate so that undue flexing of the perimeter seals is limited such that the integrity of the perimeter seals is not deteriorated. The thickness of the substrate and cover plate is not critical.

Sealed electroluminescent displays of the present invention may also comprise a conformal sealing layer directly in contact with the conductive electrodes but under the cover plate to further protect the display from atmospheric contaminants.

The perimeter seal of the present invention may be used with a variety of electroluminescent displays, such as inorganic electroluminescent displays or organic electroluminescent displays (OLEDs), more particularly, thick or thin film inorganic electroluminescent displays. Most preferably, the seals of the present invention are used with thick film inorganic electroluminescent displays. The typical thick film electroluminescent display structure comprises a set of row electrodes, a thick film dielectric layer consisting of a ferroelectric material overlies the row electrodes and is sandwiched between the row electrodes and a thin film structure. The thin film structure includes one or more thin film dielectric layers sandwiching one or more phosphor films. A set of optically transparent column electrodes is deposited on the thin film structure. Such displays are exemplified in Applicant's U.S. Pat. No. 5,432,015 (the disclosure of which is incorporated herein in its entirety).

To make the sealed electroluminescent displays of the present invention, a perimeter seal is deposited around the perimeter of a substrate with an electroluminescent display structure deposited thereon. The cover plate is disposed over the substrate such that the cover plate is sealed to the substrate around their perimeters and the electroluminescent display structure is sandwiched between the cover plate and the substrate. Should the perimeter seal comprise more than a single layer, then a further layer or layers of sealing material with or without getter material may additionally be deposited around the perimeter of the substrate. Again, it is a preferred aspect that the perimeter seal be a single layer comprising a mixture of the getter material and the sealing material. Where the perimeter seal is provided as a double layer or multilayered structure, then it is preferred that the innermost layer closest to the electroluminescent display structure contain a getter material.

In a preferred embodiment of the process for making the sealed electroluminescent display of the present invention, the getter material is mixed with the sealing material in a contaminant-free atmosphere, such as in a dry box, to avoid contaminating the getter material with moisture such that the getter material is deactivated. The loading of the getter material into the sealing material may be adjusted in order to achieve the desired contaminant absorbing capacity and contaminant absorbing efficiency in the seal.

The perimeter seal, comprising a mixture of getter material and sealing material, is deposited around the perimeter of the substrate with the electroluminescent display structure deposited thereon and/or around the perimeter of the cover plate using a bead dispenser, a stencil or by screen printing. If a double seal is used (i.e. the second embodiment of the invention), one layer comprising a mixture of getter material and sealing material and the other outer layer comprising the sealing material with or without getter material is deposited around the perimeter of the substrate and/or the cover plate using a bead dispenser, a stencil or by screen printing. This deposition step is usually carried out in the dry box to prevent moisture contamination.

The substrate and cover plate, with the seal applied thereto, may be brought together using an alignment apparatus. To prevent air from being trapped therebetween, this step is typically done under vacuum. Alternatively, a small gap can be made in the perimeter seal through which air contained within the enclosure to be sealed can flow out when the plate and substrate are pressed together. The gap must then be sealed.

The seal are then cured either by exposure to ultraviolet light through the cover plate, for UV curable adhesives, or by heating in an oven for thermally curable adhesives.

The above disclosure generally describes preferred embodiments of the present invention. A more complete understanding can be obtained by reference to the following specific Examples. These Examples are described solely for purposes of illustration and are not intended to limit the scope of the invention. Changes in form and substitution of equivalents are contemplated as circumstances may suggest or render expedient. Although specific terms have been employed herein, such terms are intended in a descriptive sense and not for purposes of limitation.

### EXAMPLES

### Example 1

This example illustrates the ability of getter material, which is mixed into a sealing material, to absorb moisture from normal ambient air. 30Y-296C UV curable adhesive obtained from Three Bond International Inc. of West Chester Ohio, USA was mixed with 20% by weight of 3× molecular sieve powder having an average particle size of about 5 micrometers. Before mixing, the molecular sieve powder was first activated at 300° C. for one hour.

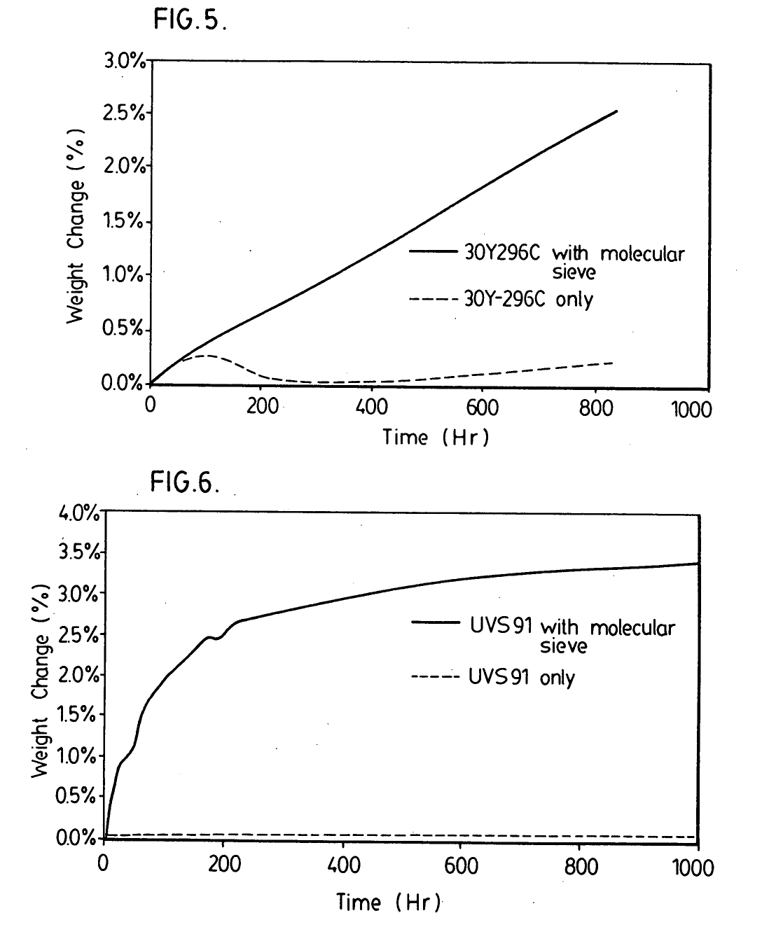

The mixed getter material and sealing material was subsequently spread on a plate to a thickness of 0.3 to 0.5 millimeters and UV cured to form a film. The film on the plate was then placed in air which contained 1500 parts per million water. The film was maintained at a temperature of about 23° C. and the weight gain of the film was monitored over time. FIG. 5 shows the weight gain of the film as a function of time. The weight of the film increased linearly over time by about 2.5% over 800 hours. For comparison, a similar film without molecular sieves was subjected to the same conditions and, as shown in FIG. 5, the film did not gain appreciable weight. Thus, the weight gain is attributed to water absorption by the molecular sieves.

### Example 2

This example is similar to Example 1, except that the sealing material consisted only of UVS91 UV curable adhesive from Norland Products Inc. of Cranbury, N.J., USA rather than 30Y-296C UV curable adhesive. The results are shown in FIG. 6. FIG. 6 shows that the weight of the film containing molecular sieves increased relatively quickly over about 200 hours by about 2.5% and then became constant at about 3%. As for Example 1, there was no appreciable weight gain when the sealing material did not contain molecular sieves. This example shows that the permeation rate for water in the UVS91 UV curable adhesive is significantly faster than it is for the blended adhesive of Example 1.

### Example 3

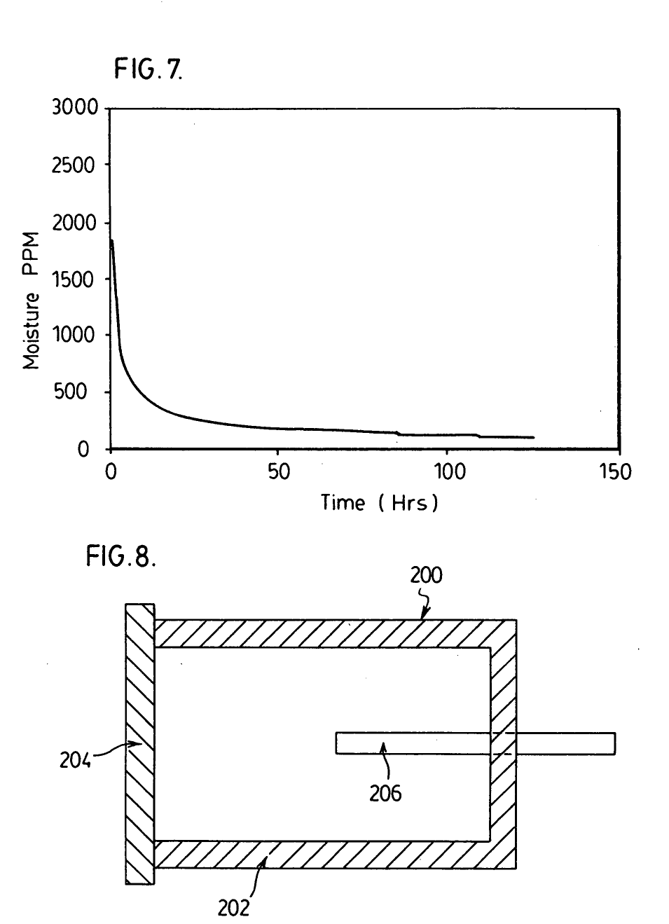

This example shows the ability of a getter material, dispersed in a sealing material, to reduce the partial pressure of water vapour in a sealed volume. A 0.225 gram sample of 13× molecular sieve dispersed in UVS91 UV curable adhesive, similar to that of Example 2, was enclosed in a 130 cm³ sealed cell fitted with a dew point probe. FIG. 7 shows the measured water vapour concentration in the cell as a function of time. The moisture content in the cell was reduced to about 100 ppm in about 100 hours, which shows the efficacy of the material to absorb water at low vapour concentrations.

### Example 4

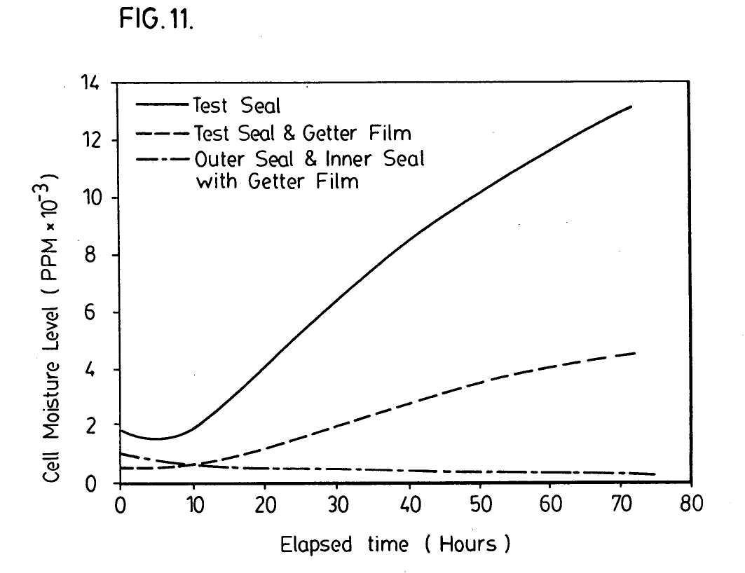

This example shows the increase in water vapour concentration in a test cell that simulates the void volume between the substrate and cover plate of an electroluminescent display and the moisture resistance of a polymeric seal between the substrate and cover plate. A cylindrical test cell 200 was constructed as shown in FIG. 8. The cylindrical test cell 200 comprised a stainless steel cylinder 202 open at one end. The cylinder 202 had a diameter of about 35 millimeters and a length of about 130 millimeters. A test seal 204, in the form of a disc comprising UVS91 UV curable adhesive, was bonded to the top of the cylinder 202 to form a nominally air-tight enclosure. The test seal 204 was about 0.3 to 0.4 millimeters thick. A dew point probe 206 was fitted into the cylindrical test cell 200 to measure the internal water vapour concentration. FIG. 11 shows the increase in water vapour concentration inside the cylindrical test cell 200 as a function of time when it was placed in a high humidity environment with a water vapour concentration of about 2.5% at a temperature of about 23° C. The cylindrical test cell 200 was assembled in air containing a water vapour concentration of about 0.15% to about 0.18%. FIG. 11 shows that the water vapour concentration in the test cell 200 rose from about 0.18% to about 1.2% after 70 hours.

### Example 5

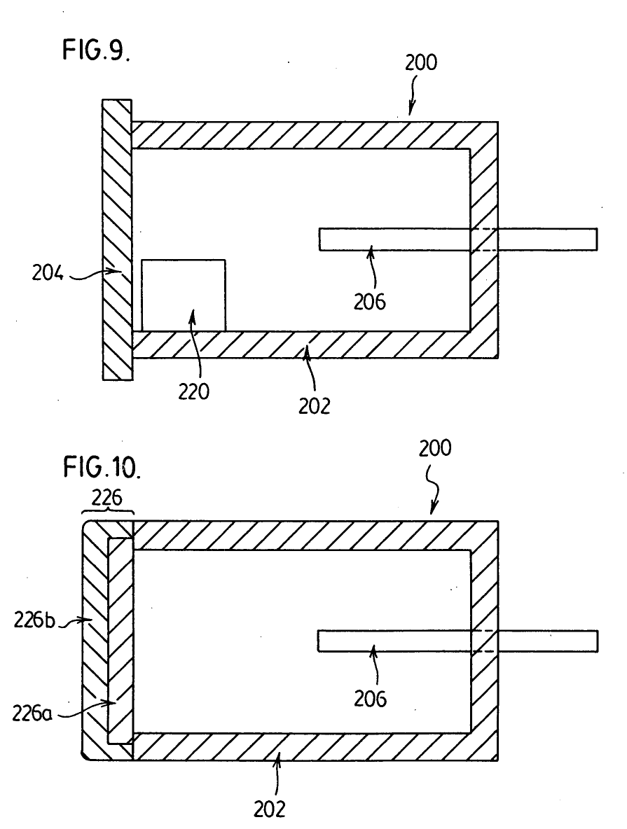

This example shows the effect of including a 0.5 millimeter thick getter film on a 4 square centimeter glass substrate 220 in the test cell 100 of Example 4, as shown in FIG. 9. The getter film comprised 13× molecular sieve mixed in 30Y-296C UV curable adhesive, similar to Example 2. The results are shown in FIG. 11. The presence of the getter significantly reduced the rate of increase of the water vapour concentration in the test cell 200 so that the concentration rose only to about 0.4% after 70 hours.

### Example 6

This example shows the effect of using a double seal 226, with the inner seal 226a containing getter material, in the test cell 200 of Example 4. In this case, the seal consisted of an inner seal 226a comprising 13× molecular sieve mixed in 30Y-296 UV curable adhesive and an outer seal 226b comprising UVS91 UV curable adhesive without molecular sieve, as shown in FIG. 10. The results are shown in FIG. 11. The water vapour pressure dropped from an initial value of about 0.15% to less than 200 parts per million after 70 hours. Thus, the seal was not only successful in preventing any penetration of moisture from the external environment, but it also successfully absorbed moisture present in the cell following assembly.

### Example 7

This example serves to show the efficacy of different seal configurations on the operating stability of a test electroluminescent device. Four test electroluminescent devices 340, 350, 360 and 370, each having a thick dielectric and a blue-emitting europium activated barium thioaluminate thin film phosphor, as exemplified in International Patent Applications WO 00/70917, WO 02/058438 and U.S. Provisional Application 60/434,639 (the disclosures of which are incorporated herein in their entirety), were constructed on 5 centimeter by 5 centimeter alumina substrates.

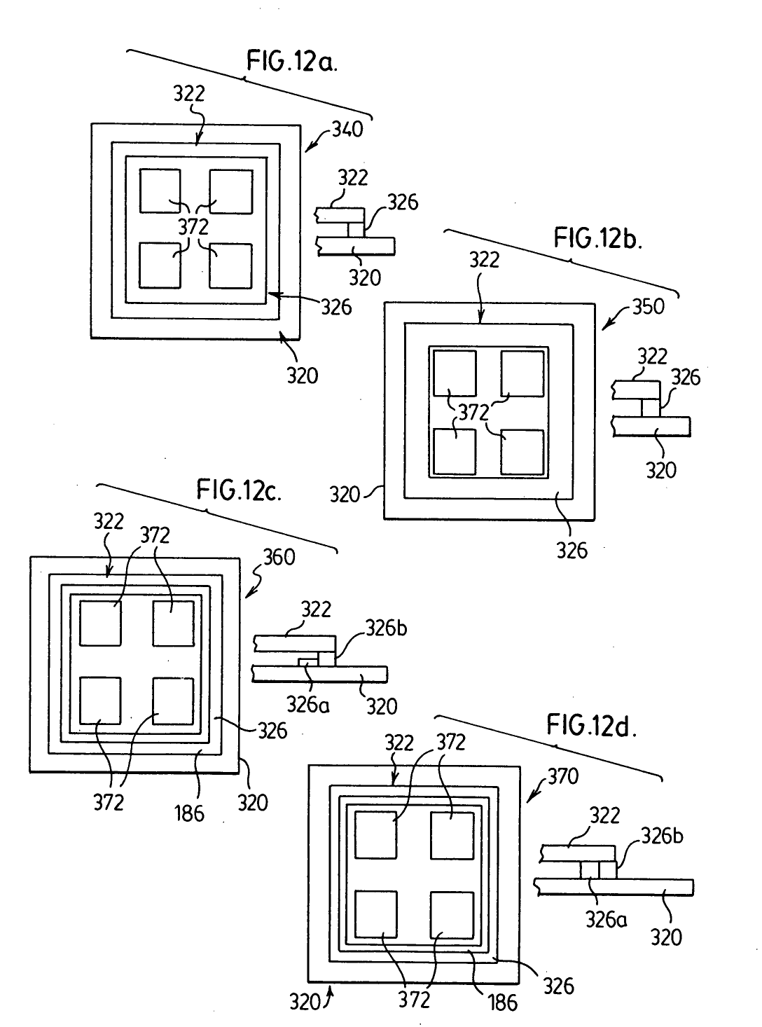

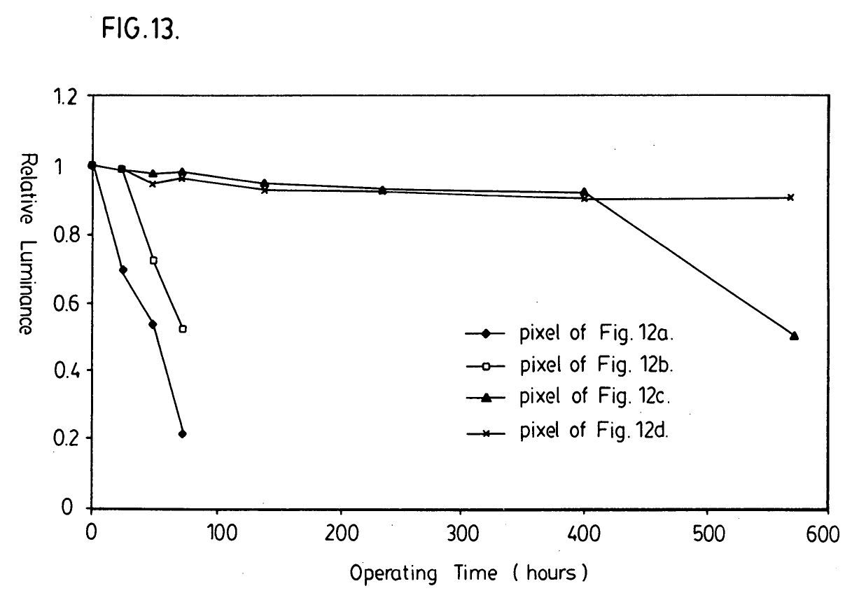

Each of the four test electroluminescent devices 340, 350, 360 and 370 contained four electroluminescent pixels 372, as shown in FIGS. 12A to 12D. Each of the devices 340, 350, 360 and 370 had a glass cover plate 322, of approximately 4 centimeters by 4 centimeters, centered over a substrate 320. The device 340 had a 2 millimeter wide by 0.5 millimeter thick perimeter seal 326. The perimeter seal 326 comprised a layer of UV curable adhesive 30Y-296C as the sealant (FIG. 12A). FIG. 12B shows a similar arrangement for the device 350, but with a 4 millimeter wide by 0.5 millimeter thick layer perimeter seal 326. FIG. 12C shows a similar arrangement for the device 360, but with the perimeter seal having an inner layer 326a consisting of 13× molecular sieve of particle size 5 micrometers dispersed in UV curable EMI 3553 epoxy from Electronic Materials Inc. of Breckenridge Colo., USA. This inner seal layer 326a was also 2 millimeters wide but only 0.35 millimeters thick so that vapour permeating the outer seal layer 326b could flow around the inner layer 326a containing the molecular sieve. FIG. 12D shows a similar arrangement for the device 370 to that of 360, but the inner seal layer 326a was 0.5 millimeters thick so that vapour permeating through the outer seal layer 326b had to pass through the inner seal layer 326a containing the molecular sieve.

FIG. 13 shows the, relative luminosity as a function of storage time for the devices 340, 350, 360 and 370 in a test chamber at a temperature of about 85° C. and about 85% relative humidity. To see the effect of storage in this environment, one of the devices was operated for short duration periods using alternating polarity voltage pulses having a voltage amplitude 60 volts above the threshold voltage for these devices at a pulse frequency of 240 Hz. As can be seen from FIG. 13, the device 340 with a 2 millimeter perimeter seal 326 (FIG. 12A) lost 50% of its initial luminance after about 50 hours storage. The device 350 with the 4 millimeter wide perimeter seal 326 (FIG. 12B) was stable for about 24 hours storage, but then lost half of it initial luminance in the next 50 hours storage, indicating that the wider seal delayed permeation of moisture through the device seal, but did not reduce the permeation rate thereafter. The device 360 with the inner perimeter seal 326 having a partial thickness (FIG. 12C) showed stable luminance for about 400 hours storage, but then lost 50% of its luminance over the next 150 hours storage. Finally, the device 370 with the seal having an inner layer 326a having a full thickness (FIG. 12D) showed stable luminance for the 570 hour storage period of the test, which showed the utility of the double seal embodiment of the invention.

Although preferred embodiments of the invention have been described herein in detail, it will be understood by those skilled in the art that variations may be made thereto without departing from the spirit of the invention.

1. A sealed electroluminescent display comprising:
a substrate;
a cover plate;
an electroluminescent display structure between the substrate and the cover plate; and
a perimeter seal extending from the substrate to the cover plate to inhibit exposure of the electroluminescent display structure to an atmospheric contaminant, the perimeter seal comprising one or more layers of a sealing material wherein at least one of said layers further comprises a getter material.

2. The sealed electroluminescent display of claim 1, wherein said perimeter seal comprises a single layer of at least one getter material and at least one sealing material.

3. The sealed electroluminescent display of claim 1, wherein said perimeter seal comprises an inner layer of at least one getter material and at least one sealing material and an outer layer comprising at least one sealing material.

4. The sealed electroluminescent display of claim 3, wherein said inner layer is adjacent and in direct contact with the outer layer.

5. The sealed electroluminescent display of claim 1, wherein said getter material is an atmospheric contaminant-immobilizing material.

6. The sealed electroluminescent display of claim 5, wherein said getter material is uniformly distributed throughout said layers of sealing material such that said atmospheric contaminant permeating through said perimeter seal is absorbed by said getter material.

7. The sealed electroluminescent display of claim 3, wherein said getter material is uniformly distributed throughout said inner layer such that said atmospheric contaminant permeating through said inner layer is absorbed by said getter material.

8. The sealed electroluminescent display of claim 1, wherein said getter material getters at least one atmospheric contaminant trapped within the electroluminescent display.

9. The sealed electroluminescent display of claim 1, wherein the concentration of said getter material is at least about 5% and at most about 50% of said sealing material volume.

10. The sealed electroluminescent display of claim 1, wherein the concentration of said getter material is between about 10 and about 30% of said sealing material volume.

11. The sealed electroluminescent display of claim 1, wherein said at least one getter material has a particle size of at most the thickness of said at least one of said at least one perimeter seal.

12. The sealed electroluminescent display of claim 1, wherein said getter material has a particle size in the range of from about 0.1 to about 250 micrometers.

13. The sealed electroluminescent display of claim 12, wherein said getter material is selected from the group consisting of alkali metal oxides, alkali metal sulfates, alkaline earth metal oxides, alkaline earth metal sulfates, calcium chloride, lithium chloride, zinc chloride, perchlorates and mixtures thereof.

14. The sealed electroluminescent display of claim 12, wherein said getter material is selected from the group consisting of molecular sieves, calcium oxide, barium oxide, phosphorus pentoxide, calcium sulfate and mixtures thereof.

15. The sealed electroluminescent display of claim 1, wherein said sealing material is selected from the group consisting of UV or thermally curable adhesives.

16. The sealed electroluminescent display of claim 3, wherein said sealing material of said inner layer is different than said sealing material of said outer layer.

17. The sealed electroluminescent display of claim 3, wherein said sealing material of said inner layer is the same as said sealing material of said outer layer.

18. The sealed electroluminescent display of claim 1, wherein said sealing material is selected from the group consisting of epoxies, phenoxies, cellulose acetates, siloxanes, methacrylates, sulfones, phthalates and mixtures thereof.

19. The sealed electroluminescent display of claim 1, wherein the viscosity of said sealing material, prior to curing, is less than about 2500 poise and greater than about 10 poise.

20. The sealed electroluminescent display of claim 1, wherein said perimeter seal occupies the entire height of a gap between the substrate and the cover plate.

21. The sealed electroluminescent display of claim 3, wherein said inner layer and said outer layer occupy the entire height of a gap between the substrate and the cover plate.

22. The sealed electroluminescent display of claim 3, wherein said inner layer and said outer layer have a thickness ranging from about 5 micrometers to about 2 millimeters.

23. The sealed electroluminescent display of claim 22, wherein said inner layer and said outer layer have a thickness ranging from about 25 micrometers to about 35 micrometers.

24. The sealed electroluminescent display of claim 3, wherein said inner layer and said outer layer have a width of from about 0.5 millimeters to about 15 millimeters.

25. The sealed electroluminescent display of claim 24, wherein said width is from about 1.5 millimeters to about 4 millimeters.

26. The sealed electroluminescent display of claim 3, wherein a gap is left between an inner edge of said inner layer and the electroluminescent display structure to allow for spreading of said inner layer.

27. The sealed electroluminescent display of claim 1, wherein the substrate is selected from the group consisting of glass, glass ceramic, ceramic, and a gas impermeable flexible substrate.

28. The sealed electroluminescent display of claim 1, wherein the cover plate is a gas impermeable optically transparent sheet material.

29. The sealed electroluminescent display of claim 28, wherein the gas impermeable optically transparent sheet material is glass.

30. The sealed electroluminescent display of claim 1, wherein the cover plate has a thermal expansion coefficient substantially matched to that of the substrate so that undue flexing of the perimeter seal is limited.

31. The sealed electroluminescent display of claim 1 further comprising a conformal sealing layer between the cover plate and the electroluminescent display structure.

32. The sealed electroluminescent display of claim 1, wherein the electroluminescent display structure is selected from the group consisting of a thick film dielectric electroluminescent display structure and a thin film electroluminescent display structure.

33. The sealed electroluminescent display of claim 3, wherein the electroluminescent display structure is selected from the group consisting of a thick film dielectric electroluminescent display structure and a thin film electroluminescent display structure.

34. The sealed electroluminescent display of claim 33, wherein the electroluminescent display structure is a thick film dielectric electroluminescent display structure.

35. A process for making a sealed electroluminescent display comprising:
depositing a perimeter seal around the perimeter of a substrate and/or a cover plate, the substrate having an electroluminescent display structure deposited thereon, wherein said perimeter seal comprises a mixture of at least one getter material and at least one sealing material; and
disposing the cover plate over the substrate such that the cover plate is sealed to the substrate and the perimeter seal contacts both the cover plate and the substrate.

36. The process of claim 35, wherein said perimeter seal comprises an inner layer and an outer layer, wherein said inner layer and said outer layer comprises the mixture of said at least one getter material and said at least one sealing material.

37. The process of claim 36, wherein the inner layer comprises said mixture of said at least one getter material and said at least one sealing material and the outer layer comprises at least one sealing material.

38. The process of claim 35, wherein the process is carried out in a substantially contaminant-free atmosphere.

39. The process of claim 38, wherein the process is carried out in a dry box.

40. The process of claim 35, wherein said e perimeter seal is deposited using at least one of a bead dispenser, a stencil and by screen printing.

41. The process of claim 37, wherein said inner layer and said outer layer is deposited using at least one of a bead dispenser, a stencil and by screen printing.

42. The process of claim 37, wherein an alignment apparatus is used to dispose the cover plate over the substrate.

43. The process of claim 35, wherein said perimeter seal is cured.

44. The process of claim 43, wherein said perimeter seal is cured by a method selected from exposure to ultraviolet light and/or heating.

45. The process of claim 35, wherein the electroluminescent display structure is selected from the group consisting of a thick film dielectric electroluminescent display structure and a thin film electroluminescent display structure.

46. The process of claim 37, wherein the electroluminescent display structure is selected from the group consisting of a thick film dielectric electroluminescent display structure and a thin film electroluminescent display structure.

47. The process of claim 45, wherein the electroluminescent display structure is said thick film dielectric electroluminescent display structure.

48. A perimeter seal provided within an electroluminescent display having a substrate, a cover plate and an electroluminescent display structure between the substrate and the cover plate; wherein the perimeter seal extends from and contacts both the substrate and the cover plate to inhibit exposure of the electroluminescent display structure to an atmospheric contaminant, and wherein the perimeter seal is a layer comprising sealing material and getter material.

49. The seal of claim 48, wherein said perimeter seal additionally comprises an outer layer of a sealant material.

50. The seal of claim 49, wherein said outer layer further comprises one or more getter materials.

51. The seal of claim 49, wherein said outer layer additionally comprises one or more further outer layers of sealing material, each of said further outer layers provided with or without one or more getter materials.

52. The seal of claim 49, wherein said layer, outer layer or further outer layers is adjacent and in direct contact with each other.

53. The seal of claim 48, wherein said seal is not in contact with said electroluminescent display structure.

54. A perimeter seal provided within an electroluminescent display having a substrate, a cover plate and an electroluminescent display structure between the substrate and the cover plate; wherein the perimeter seal extends from and contacts both the substrate and the cover plate to inhibit exposure of the electroluminescent display structure to an atmospheric contaminant, and wherein the perimeter seal comprises an inner layer comprising sealing material and one or more outer layers, wherein one or more of said outer layers additionally comprises one or more getter materials.

55. The process of claim 46, wherein the electroluminescent display structure is said thick film dielectric electroluminescent display structure.

56. The seal of claim 51, wherein said layer, outer layer or further outer layers is adjacent and in direct contact with each other.
